(19) United States
(12) Patent Application Publication
(10) Pub. No.: US 2007/0043198 A1
(43) Pub. Date: Feb. 22, 2007

(54) Paintable two-component polyurethane sealant

(75) Inventor: Edmund J. Madaj, Manchester, MI (US)

Correspondence Address: CURATOLO SIDOTI CO., LPA, 24500 CENTER RIDGE ROAD, SUITE 280, CLEVELAND, OH, 44145, US

(73) Assignee: Construction Research & Technology GmbH, Trostberg (DE)

(21) Appl. No.: 11/499,553

(22) Filed: Aug. 4, 2006

Related U.S. Application Data
(60) Provisional application No. 60/708,838, filed on Aug. 17, 2005.

(51) Int. Cl. C08G 18/00

(52) U.S. Cl. 528/44

(57) ABSTRACT

A polyurethane sealant is provided with the properties of low modulus, high elongation, and good paint adhesion. The polyurethane sealant is prepared using a hydroxy-terminated polyoxyalkylene polyol prepolymer in the base component of the formulation, and an isocyanate-terminated polyisocyanate prepolymer in the activator component. The polyurethane sealant is also characterized in that no more than about 20 percent by weight of the polyoxyalkylene portion of the polyols used to prepare the prepolymer components used in the production of the sealant has a hydroxyl equivalent weight greater than about 1600.

### CROSS REFERENCE TO RELATED APPLICATIONS

This application claims the benefit of the filing date of U.S. Provisional Application for Patent Ser. No. 60/708,838 filed Aug. 17, 2005, which is hereby incorporated by reference as if fully written out below.

### BACKGROUND

Sealants are used to isolate an environment, serving as a barrier to the passage of gases, liquids, and solid particles. Sealants also serve to attenuate mechanical shock, vibration, and sound, maintain a pressure differential, and protect items mechanically, electrically, and thermally.

The largest use of sealants is in commercial and home construction and repair, and in the transportation market. Exterior commercial construction sealants must accommodate large changes in joint gap or width from temperature cycling and wind loads. In addition, the sealants must resist rain, heat, ultraviolet light, oxygen, and ozone. Building materials such as stone, marble, aluminum, steel, glass, and plastics differ widely in thermal coefficients of expansion, so joint design is very important for sections of different materials that are fitted together. The gap width between sections is based on material type and length of section, with a wider gap for larger sections. Sealants are commonly used for expansion joints in parking decks.

Only high performance sealants are suitable for commercial building and construction for exterior sealing. High performance sealants can typically accommodate significant joint movement in compression or tension with good recovery.

Polyurethanes have suitable properties for many useful products, including elastomeric sealants prepared from the reaction of hydroxy-functional components with isocyanate-functional components. Polyurethanes have utility as high performance sealants.

Sealants are typically painted for aesthetic purposes to match sections of building material, and also to impart increased weathering protection. Sealants typically are not paintable in the absence of a primer, and thus require at least two paint application steps, the first with a primer or tiecoat, and a second application step using a standard paint or topcoat for aesthetic or protective purposes. Adequate performance, including adhesion of the paint to the sealant, is typically not obtained in the absence of a primer.

What is needed in the art is a high performance sealant that is paintable in the absence of a primer, thus saving the time and expense of a primer application step. What is also needed in the art is a high performance sealant with an appropriately low modulus to accommodate significant joint movement in compression or tension.

### SUMMARY

A polyurethane sealant is provided which comprises the reaction product of a hydroxy-terminated polyisocyanate/polyoxyalkylene polyol prepolymer base component, and an isocyanate terminated polyisocyanate/polyoxyalkylene polyol prepolymer activator component, wherein the polyurethane sealant is paintable in the absence of primer and no more than about 20 percent by weight of the polyoxyalkylene portion of the polyols used to prepare the prepolymer components have a hydroxyl equivalent weight greater than about 1600.

### DETAILED DESCRIPTION

A polyurethane sealant is provided with the properties of low modulus, high elongation, and good paint adhesion. The polyurethane sealant is prepared using a hydroxy-terminated polyisocyanate/polyoxyalkylene polyol prepolymer in the base component of the formulation, and an isocyanate-terminated polyisocyanate/polyoxyalkylene polyol prepolymer in the activator component. These prepolymers are distinguished by the composition of the polyoxyalkylene polyols used in their preparation.

The hydroxy-terminated polyoxyalkylene polyol prepolymers used in the polyurethane sealant are prepared by reacting a polyisocyanate with an excess of a polyoxyalkylene polyol, such as a polyoxyalkylene diol, a polyoxyalkylene triol, or a mixture thereof, with an average hydroxyl equivalent weight of below 1600. In certain embodiments, the hydroxy terminated polyoxyalkylene polyol prepolymer may comprise a polyether based polyurethane polymer. So-called “polymer polyols” (prepared by grafting another polymer on to the polyether chains) with higher hydroxyl equivalent weights than about 1600 may be used to make the hydroxy-terminated prepolymer, provided that the polyether polyols used in their preparation have hydroxyl equivalent weights below about 1600.

To produce an isocyanate-terminated polyurethane prepolymer, a polyoxyalkylene polyol, such as those described above with respect to the hydroxy-terminated prepolymer, is reacted with an excess of polyisocyanate. The amount of polyisocyanate used is sufficient to provide a ratio of isocyanate equivalence to polyol equivalence of about 1.1:1 to about 5:1. The particular ratio used depends primarily on the desired flexibility characteristics of the sealant, with flexibility decreasing as this ratio increases.

The polyurethane sealant is also characterized in that no more than about 20 percent by weight of the polyoxyalkylene portion of the polyols used to prepare the prepolymer components used in the production of the sealant has a hydroxyl equivalent weight greater than about 1600. Higher equivalent weight polyols may negatively affect the paintability of the polyurethane sealant.

In certain embodiments, the base component containing a hydroxyl-terminated polyurethane prepolymer is made with polyoxypropylene diols and triols such that at least 20 percent of the polyols used in the prepolymer have hydroxyl equivalent weights less than about 1000 but greater than about 100.

Also, in certain embodiments, the isocyanate terminated prepolymer in the activator component, is made with polyoxypropylene diols and triols such that at least 20 percent of the starting polyols have hydroxyl equivalent weights less than about 1000, in some embodiments less than about 600 or about 700, but greater than about 50.

The prepolymers may be prepared either in a single step, or by a step-wise process similar to those described in U.S. Pat. Nos. 3,049,516 and 3,386,962 both of which are incorporated by reference herein. Prepolymers as defined herein, prepared by either process, produce sealants that exhibit paintability as measured by ASTM D 3359 Standard Method for Measuring Adhesion by Tape Test.

The subject polyurethane sealant provides excellent paintability, defined as a high level adhesion between the sealant and an applied paint that can be measured by ASTM D 3359. The subject polyurethane sealant also provides very good tensile properties, characterized as having relatively low modulus (defined for purposes of this Specification as a tensile stress at 100% elongation).

Other performance capabilities of the sealant can be expressed in terms of measured physical properties such as tensile strength, elongation percentage, and tensile stress at 100% elongation, often referred to as 100% modulus, measured by a standard test method such as ASTM D 412. Tensile strength is the force, measured in units such as pounds per square inch or psi, needed to stretch a material until it breaks. Elongation percentage or elongation at break is how much the material stretches before it breaks, as a percentage of its original dimensions. The 100% modulus is the force needed to stretch the material to twice its original dimensions.

The polyoxyalkylene polyol of the hydroxy-terminated and isocyanate-terminated prepolymers used to prepare the polyurethane sealant may comprise a diol, triol or higher functionality polyol, and may be selected from the group consisting of polyether polyols, polyester polyols, and combinations thereof.

For illustration purposes but not by way of limitation, the polyoxyalkylene polyol may be selected from the group consisting of polyethylene glycols, polypropylene glycols, polytetramethylene glycols, polyoxyalkylene diols and triols, polycaprolactone diols and triols, and combinations thereof.

Polyoxyalkylene polyols include polyethers prepared by the copolymerization of cyclic ethers selected from the group consisting of ethylene oxide, propylene oxide, trimethylene oxide, tetrahydrofuran, and mixtures of these cyclic ethers, with aliphatic polyols selected from the group consisting of ethylene glycol, 1,3-butanediol, diethylene glycol, dipropylene glycol, 1,2-propylene glycol, 1,3-propylene glycol, 1,4-butylene glycol, and mixtures of these aliphatic polyols. Representative polyoxyalkylene polyols include the above-described polyethers, polyethylene glycols, polypropylene glycols, polytetramethylene glycols, and mixtures thereof.

Examples of appropriate hydroxyl equivalent weight polyoxyalkylene polyols that may be used in the preparation of the hydroxy-terminated and isocyanate-terminated prepolymers used to prepare the polyurethane sealant include but are not limited to Voranol™ 220-110, Voranol™ 220-056N, Voranol™ 230-056N (available from Dow Chemical Company, Midland, Mich.), and Arcol™ 34-28 (available from Bayer Corporation).

Examples of higher hydroxyl equivalent weight polyoxyalkylene polyols, whose quantity is restricted in the preparation of the hydroxy-terminated and isocyanate-terminated prepolymers as discussed above, include but are not limited to Voranol™ 220-028 (available from Dow Chemical Company, Midland, Mich.), as well as Acclaim™ 4200, Acclaim™ 6300, Acclaim™ 8200 and Acclaim™ 12200 (available from Bayer Corporation, Pittsburgh, Pa.).

In certain embodiments, the polyoxyalkylene polyol of the polyurethane sealant has a molecular weight in the range of about 500 to about 4500. In other embodiments, the polyol has a molecular weight in the range of about 500 to about 3000. The molecular weight is either a calculated molecular weight, i.e. the sum of the atomic weights of the atoms making up the material, or the molecular weight is a number average molecular weight determined based on end group analysis or measurement of colligative properties by ebulliometry, cryoscopy, or membrane osmometry.

In one embodiment the polyisocyanates may comprise aromatic isocyanates such as methylene diphenyl diisocyanates (MDI), toluene diisocyanates (TDI), polymeric methylene diphenyl diisocyanate (PMDI), p-phenyl diisocyanate (PDI), naphthalene diisocyanate (NDI), aliphatic isocyanates such as hexamethylene diisocyanates (HDI), hexamethylene diisocyanate trimers (HDI Trimers), dicyclohexylmethane diisocyanates (H₁₂MDI), isophorone diisocyanates (IPDI), cyclohexane diisocyanate (CHDI), tetramethylxylylene diisocyanate (TMXDI).

In another embodiment suitable polyisocyanates may include diisocyanates such as m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotolylene diisocyanate (and isomers), naphthylene-1,5-diisocyanate, 1-methoxyphenyl-2,4-diisocyanate, diphenylmethane-4,4′-diisocyanate, 4,4′-biphenylene diisocyanate, 3,3′-dimethoxy-4,4′-biphenyl diisocyanate, 3,3′-dimethyl-4,4′-biphenyl diisocyanate; and 3,3′-dimethyldiphenylmethane-4,4′-diisocyanate; triisocyanates such as 4,4′,4″-triphenylmethane triisocyanate, polymethylene polyphenylisocyanate and toluene, 2,4,6-triisocyanate; and tetraisocyanates, such as 4,4′-dimethyldiphenylmethane-2,2′-5, 5′-tetraisocyanate.

In certain embodiments the free % NCO (NCO-content) isocyanate may be 1% to 12% by weight of the reaction product. In another embodiment the isocyanate may be about 2% to 6% free NCO by weight of the reaction product.

The free % NCO is defined as the weight percent of a substance that is available for reaction, either as free isocyanate monomer or as unreacted isocyanate (NCO-groups) in a polymer, prepolymer, or quasi-prepolymer. This concept is known to those skilled in the art.

The polyurethane sealant may comprise additional components which may include but are not limited to thixotropic agents, fillers, plasticizers, antioxidants, UV stabilizers, fungicides, mildewcides, biocides, fire retardants, coloring agents, surface additives, adhesion promoters, rheology modifiers, catalysts, defoaming agents, solvents, drying agents and the like.

In one embodiment the total amount of such additives can be about 10 to about 50 weight percent; and in some embodiments about 25 to about 40 weight percent, based on the total weight of the sealant. By way of example, but not of limitation, the sealant may contain from 0 to about 5 percent by weight of UV absorbers, from 0 to about 5 percent by weight of antioxidants, from 0 to about 2 percent by weight of mildewcides, from 0 to about 2 percent by weight of biocides, from 0 to about 2 percent by weight of fungicides, from 0 to about 20 percent by weight of fire or flame retardants, from about 20 to about 50 percent by weight of fillers, from 0 to about 10 percent by weight of pigments, from 0 to about 5 percent by weight of catalysts, from 0 to about 5 percent by weight of adhesion promoters, from 0 to about 10 percent by weight of flow and leveling additives, from 0 to about 5 percent by weight of wetting agents, from 0 to about 2 percent by weight of antifoaming agents, and/or from 0 to about 20 percent by weight of rheology modifiers.

Various fillers can be used in the polyurethane sealant, including talc, ground calcium carbonate, precipitated calcium carbonate, asbestos, carbon black, titanium dioxide, glass, such as crushed glass or glass spheres, metal such as iron particles, quartz, silica such as hydrophilic silica, hydrophobic amorphous fumed silica, and amorphous precipitated silica, barytes, acrylates, limestone, sulfates, alumina, various clays, diatomaceous earth, wollastonite, mica, perlite, flint powder, kryolite, alumina trihydrate, polymer granules and powders such as granulated or micronized polyethylene and granulated or micronized polypropylene, melamine, fibers such as polypropylene or nylon, zinc oxide, and mixtures thereof. Carbon black and titanium dioxide may be used as both a filler and a pigment.

The polyurethane sealant may also comprise a rheology modifier to increase the viscosity of the material immediately after application to a substrate. This can prevent the sealant from dripping or running when initially applied to a substrate. Examples of the rheology modifier include, but are not limited to, fumed silica, polyamide waxes, modified castor oil, and clay intercalated with organic cations, acrylates, PVC plastisols, polyurea-plasticizer dispersions. Talc may be used as both a filler and rheology modifier.

Various plasticizers which are noncombustible, have a relatively low viscosity and are compatible with the urethane matrix can be used in the polyurethane sealant. While not required, a solvent can be used to aid processing and/or as a diluent. In some embodiments the plasticizer can function both as a plasticizer and a solvent. Plasticizers such as nonvolatile organic liquids and low-melting solids, such as hydrogenated petroleum distillates, coal tar distillates, and other organic liquids having a boiling point higher than 30° C., phthalates (for example, diisodecyl phthalate and dioctyl phthalate) and adipates (for example, 2-ethylhexyl adipate) can be used. Other materials conventionally used as a plasticizer and/or solvent in polyurethane sealant formulations, such as methylene chloride, naphthol spirits, xylene and mixed spirits, can also be used. If used, in one embodiment the amount of plasticizer (solvent) may be up to about 4 weight percent.

An antioxidant can be added to the polyurethane sealant to improve the long-term oxidation resistance of the sealant. Antioxidants may comprise alkylated monophenols, alkylthiomethylphenols, hydroquinones and alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, benzylphosphonates, acylaminophenols, esters of beta-(3,5-di-tert-butyl-4-hydroxyphenyl)propionic acid with mono- or polyhydric alcohols, esters of beta-(5-tert-butyl-4-hydroxy-3-methylphenyl)propionic acid with mono- or polyhydric alcohols, esters of beta-(3,5-dicyclohexyl-4-hydroxyphenyl)propionic acid with mono- or polyhydric alcohols, esters of 3,5-di-tert-butyl-4-hydroxyphenyl acetic acid with mono- or polyhydric alcohols, amides of beta-(3,5-di-tert-butyl-4-hydroxyphenyl)propionic acid, ascorbic acid and derivatives, aminic antioxidants, and mixtures thereof. If used, the amount of antioxidant in one embodiment can be about 0.3 to about 1.0 weight percent, based on the total weight of the sealant. Various commercially available antioxidants can be used, such as IRGANOX 1076, an octadecyl 3,5-di-tert-butyl 4-hydroxyhydrocinnamate marketed by Ciba Corporation.

If included in the polyurethane sealant formulation, UV stabilizers may comprise 2-(2′-hydroxyphenyl)benzotriazoles, 2-hydroxybenzophenones, esters of substituted and unsubstituted benzoic acids, acrylates, nickel compounds, sterically hindered amines, oxanilides, 2-(2-hydroxyphenyl)-1,3,5-triazines, and mixtures thereof.

Fungicides, mildewcides, and biocides if used in the polyurethane sealant may comprise 4,4-dimethyloxazolidine, 3,4,4-trimethyloxazolidine, modified barium metaborate, potassium N-hydroxy-methyl-N-methyldithiocarbamate, 2-(thiocyanomethylthio) benzothiazole, potassium dimethyl dithiocarbamate, adamantane, N-(trichloromethylthio) phthalimide, 2,4,5,6-tetrachloroisophthalonitrile, orthophenyl phenol, 2,4,5-trichlorophenol, dehydroacetic acid, copper naphthenate, copper octoate, organic arsenic, tributyl tin oxide, zinc naphthenate, copper 8-quinolinate, and mixtures thereof.

Fire retardants, if used in the polyurethane sealant, may comprise any material that provides self-extinguishing properties. Examples of the fire retardant include, but are not limited to, phosphates such as triphenyl phosphate, polyammonium phosphate, monoammonium phosphate, or tri(2-chloroethyl) phosphate, exfoliated graphite, acid treated natural graphite flakes, and mixtures thereof. The fire retardant can be a liquid or a solid. A solid fire retardant may be ground to a micron size, typically referred to by those skilled in the art as micronized. Additionally, the fire retardant may include but is not limited to self-extinguishing agents and flame-retardants. In one embodiment, the fire retardant may be polyammonium phosphate. In another embodiment, aluminum oxide smoke retardant may be used in combination with polyammonium phosphate.

The polyurethane sealant may also comprise a coloring agent, such as a pigment or a dye, to provide a desired color to the sealant. Examples of coloring agents are carbon black and titanium dioxide which may be in the rutile form, but other coloring agents are also useful. Carbon black and titanium dioxide may act as both pigments and fillers in the sealant. Additional examples of pigments include, but are not limited to, barium sulfate, zinc oxide, zinc sulfide, basic lead carbonate, antimony trioxide, lithopones (zinc sulfide and barium sulfate), inorganic color pigments such as iron oxides, carbon black, graphite, luminescent pigments, zinc yellow, zinc green, ultramarine, manganese black, antimony black, manganese violet, Paris blue, and Schweinfurter green, organic color pigments such as sepia, gamboge, Cassel brown, toluidine red, para red, Hansa yellow, indigo, azo dyes, anthraquinonoid and indigoid dyes, as well as dioxazine, quinacridone, phthalocyanine, isoindolinone, and metal complex pigments, and mixtures thereof.

The polyurethane sealant may additionally comprise surface additives such as flow and leveling additives, wetting agents, and antifoaming agents to facilitate application of the material. Examples of flow and leveling additives, wetting agents, and antifoaming agents include silicones, modified silicones, polyacrylates, and hydrocarbons such as petroleum components and mixtures. Examples of suitable flow additives include, but are not limited to, polyester modified acrylic functional poly-dimethyl siloxanes such as BYK®-371, BYK® P-104, and polyacrylate copolymers such as BYK®-358, (all available from BYK-Chemie USA, Wallingford, Conn.), and fluorosurfactants such as 3M™ FLUORAD™ FC-4430 Fluorosurfactant (available from 3M Company, St. Paul, Minn.).

Adhesion promoters can also be used in the polyurethane sealant. Examples of adhesion promoters include, but are not limited to γ-glycidoxypropyltrimethoxysilane, γ-glycidoxypropyltriethoxysilane, γ-mercaptopropyltrimethoxysilane, γ-mercaptopropyltriethoxysilane, and, γ-ureidopropyltrimethoxysilane, and γ-ureidopropyltriethoxysilane.

One or more conventional catalysts that accelerate the isocyanate-polyol reaction can be used, including tertiary amines, organo metallic compounds and mixtures thereof.

Tertiary amines such as triethylenediamine, dimethylethanolamine, triethanolamine, N-ethyl morpholine, N-methyldicyclohexylamine, N,N-dimethyl cycolhexylamine, N,N,N′,N′-tetramethyl-1,3-butanediamine, ether and the like can be used.

Organo metallic compounds such as tin compounds such as stannous octoate, stannous chloride, dibutyltin dilaurate, dibutyltin diacetate, dibutyltin-di-2 ethyl hexoate and the like. Other suitable organometallic compounds include bismuth octoate, zinc octoate and the like can be used.

The amount of catalysts, if used, may be in one embodiment about 0.001 to about 1 weight percent and in another embodiment about 0.05 to about 0.3, weight percent, based on the total weight of the sealant. A complexing agent that reacts with the catalyst to slow down its reactivity after the sealant has been packaged can be used in one embodiment, such as diethyl malonate. When used, the amount of the complexing agent in one embodiment usually is about 0.05 to about 1 weight percent, and in another embodiment about 0.1 to about 0.5 weight percent, based on the total weight of the sealant.

In one process for producing a sealant, the polyisocyanate is introduced into a covered mixing vessel or tank and the polyol is added to the polyisocyanate with mixing under an atmosphere of dry gas, such as nitrogen. The complexing agent (diethyl malonate), inhibitor (phosphoric acid), catalyst and antioxidant are added with mixing under a dry nitrogen blanket and the resulting mixture is mixed for approximately about 1.5 to about 2 hours to form a reaction mixture containing an isocyanate-terminated prepolymer and unreacted isocyanate.

In certain embodiments, a polyurethane sealant is provided, wherein the sealant may have a 100 percent modulus of less than about 100 psi. In other embodiments, the polyurethane sealant may have a 100 percent modulus of about 20 psi to about 95 psi. In yet other embodiments, the polyurethane sealant may have a 100 percent modulus of about 40 psi to about 90 psi.

In certain embodiments, the polyurethane sealant may have a tensile strength of about 90 psi or greater. In other embodiments, the polyurethane sealant may have a tensile strength of about 100 psi or greater. In yet other embodiments, the polyurethane sealant may have a tensile strength of about 110 psi or greater.

In certain embodiments, the polyurethane sealant may have an elongation at break of about 200 percent or greater. In other embodiments, the polyurethane sealant may have an elongation of about 240 percent or greater. In yet other embodiments, the polyurethane sealant may have an elongation of about 280 percent or greater.

Improved performance is typically obtained for clean and dry substrate surfaces. Surface preparation before sealant application can include water-blasting, sandblasting, cleaning, and drying of concrete surfaces, cleaning of metal surfaces with organic solvents, scuff-sanding and organic solvent wiping of composite surfaces, flame-etching of plastic surfaces, and the like.

When applied to a substrate, in certain embodiments, a polyurethane sealant is provided that is at least about 0.25 inch thick. In other embodiments, the polyurethane sealant is about 0.25 inch to about 0.5 inch thick. In yet other embodiments, the polyurethane sealant is about 0.125 inch to about 0.75 inch thick.

When utilized as an expansion joint for a parking deck, in certain embodiments, a polyurethane sealant is provided that is at least about 0.25 inch thick. In other embodiments, the polyurethane sealant is about 0.25 inch to about 1 inch thick. In yet other embodiments, the polyurethane sealant is about 0.25 inch to about 1.25 inch thick.

Paint adhesion is typically evaluated using a standard test method such as ASTM D3359. Using this crosshatch adhesion test method, a rating of 5B is given to the sample if the edges of the cuts are completely smooth and none of the squares of the lattice is detached, therefore 100% adhesion and 0% adhesion failure. A rating of 4B applies if small flakes of the coating are detached at intersections of cuts, and less than 5% of the area is affected, therefore 5% adhesion failure. A rating of 3B applies if small flakes of the coating are detached along edges and at intersections of cuts, and the adhesion failure area is 5 to 15% of the lattice. A rating of 2B applies if the coating has flaked along the edges and on parts of the squares, and the adhesion failure area is 15 to 35% of the lattice. A rating of 1B applies if the coating has flaked along the edges of cuts in large ribbons and whole squares have detached, and the adhesion failure area is 35 to 65% of the lattice. A rating of 0B applies if flaking and detachment is worse than Grade 1B, corresponding to adhesion failure area of greater than 65% of the lattice.

In one embodiment, the polyurethane sealant reaction product is paintable in the absence of a primer such that paint adheres to the surface of the sealant with a rating of at least 4B when tested according to the paint adhesion test ASTM D3359. The types of paint that adhere to the surface of the sealant include water based paints, such as latex paint, among others.

The following example is given to illustrate the preparation of a polyurethane sealant as discussed above.

The sample in Table 1 was prepared using the following components:
Polyol A: A polyoxypropylene triol with ethylene oxide capping, and styrene-acrylonitrile grafted on to the polyether backbone. The hydroxyl equivalent weight of this polyol is about 2000, but the polyether polyol used to prepare this product has a hydroxyl equivalent weight of about 1550.
Prepolymer A: The product of the reaction of 500.18 parts of Polyol A with 12.6 parts of toluenediisocyanate.
Polyol B: A polyoxypropylene glycol having a hydroxyl equivalent weight of about 510.
Prepolymer B: The product of the reaction between 481.33 parts of Polyol B with 72.3 parts of toluenediisocyanate. The polyol is first dried by addition of 8.9 parts of calcium oxide followed by vigorous agitation of the mixture with heating. The entire process is carried out under an atmosphere of dry nitrogen.
Filler A: Calcium carbonate with an average particle size of about 3 microns.
Filler B: A stearic acid coated calcium carbonate with an average particle size of about 0.07 microns.
   1,4-butanediol.
Isocyanate A: A prepolymer prepared by reacting a polyoxypropylene triol with two equivalents of toluenediisocyanate and containing 0.046% bismuth neodecanoate.
Isocyanate B: A commercial isocyanate-terminated prepolymer made from diphenylmethane diisocyanate and a polyol, and having about 23% free isocyanate.
A100: An acrylic latex primer available from Sherwin-Williams, Inc.
Colorflex™: An acrylic elastomeric coating available from Degussa Building Systems.
   Test Methods:

Paintability was measured according to ASTM D3359 Standard Test Methods for Measuring Adhesion by Tape Test.

ASTM D412 Standard Test Methods for Vulcanized Rubber and Thermoplastic Elastomers—Tension

An example of the performance of polyurethane sealants made according to the foregoing is set forth in the following table.

TABLE 1

| Sample | |
|---|---|
| Prepolymer A | 20.1 |
| Prepolymer B | 26.8 |
| Filler A | 20.1 |
| Filler B | 20.1 |
| 1,4-Butanediol | 0.34 |
| Isocyanate A | 11.1 |
| Isocyanate B | 1.4 |
| Paintability (D3359 Method B) | |
| A100 | 4B |
| Colorflex ™ | 4B |
| Tensile properties (ASTM D412) | |
| 100% modulus | 55 psi |
| Ultimate tensile stress | 265 psi |
| Elongation at break | 708% |

Polyurethane sealants made according to the foregoing description demonstrate high elongations, low moduli, and are paintable with common water-based paints. Their tensile and elongation properties translate into excellent movement capability according to industry test methods.

It will be understood that the embodiment(s) described herein is/are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

I claim:

1. A polyurethane sealant comprising the reaction product of:
a) a hydroxy-terminated polyisocyanate/polyoxyalkylene polyol prepolymer base component; and
b) an isocyanate terminated polyisocyanate/polyoxyalkylene polyol prepolymer activator component;
wherein the polyurethane sealant is paintable in the absence of primer and no more than about 20 percent by weight of the polyoxyalkylene portion of the polyols used to prepare the prepolymer components have a hydroxyl equivalent weight greater than about 1600.

2. The polyurethane sealant of claim 1 wherein the polyoxyalkylene polyols of the reaction product has a molecular weight in the range of about 500 to about 4500.

3. The polyurethane sealant of claim 1 wherein the polyoxyalkylene polyol comprises a diol, a triol or higher functionality polyol.

4. The polyurethane sealant of claim 1 wherein the polyoxyalkylene polyol is at least one of polyether polyols, polyester polyols, or combinations thereof.

5. The polyurethane sealant of claim 1 wherein the polyoxyalkylene polyol is at least one of polypropylene glycols, polyethylene glycols, polytetramethylene glycols, polycaprolactone diols, polycaprolactone triols, or combinations thereof.

6. The polyurethane sealant of claim 1 wherein the polyisocyanate comprises at least one of methylene diphenyl diisocyanates, toluene diisocyanates, polymeric methylene diphenyl diisocyanate, p-phenyl diisocyanate, naphthalene diisocyanate, hexamethylene diisocyanates, hexamethylene diisocyanate trimers, dicyclohexylmethane diisocyanates, isophorone diisocyanates, cyclohexane diisocyanate, tetramethylxylylene diisocyanate, or mixtures thereof.

7. The polyurethane sealant of claim 1 wherein the ratio of polyisocyanate equivalents to polyol equivalents is about 1.1:1 to about 5:1.

8. The polyurethane sealant of claim 1 wherein the polyurethane sealant additionally comprises at least one of thixotropic agents, fillers, plasticizers, antioxidants, UV stabilizers, fungicides, mildewcides, biocides, fire retardants, coloring agents, surface additives, adhesion promoters, rheology modifiers, catalysts, defoaming agents, solvents, drying agents, or mixtures thereof.

9. The polyurethane sealant of claim 1 wherein the prepolymer base component is made with polyoxypropylene diols and triols such that at least 20 percent of the polyols used in the prepolymer have hydroxyl equivalent weights less than about 1000 but greater than about 100.

10. The polyurethane sealant of claim 1 wherein the prepolymer activator component is made with polyoxypropylene diols and triols such that at least 20 percent of the starting polyols have hydroxyl equivalent weights less than about 1000, but greater than about 50.

11. A method of providing a polyurethane sealant that is paintable with a water based paint in the absence of a primer comprising:
providing for the formation of a reaction product,
a) a hydroxy-terminated polyisocyanate/polyoxyalkylene polyol prepolymer base component; and
b) an isocyanate terminated polyisocyanate/polyoxyalkylene polyol prepolymer activator component;
wherein no more than about 20 percent by weight of the polyoxyalkylene portion of the polyols used to prepare the prepolymer components have a hydroxyl equivalent weight greater than about 1600.

12. The method of claim 11 wherein the prepolymer base component is made with polyoxypropylene diols and triols such that at least 20 percent of the polyols used in the prepolymer have hydroxyl equivalent weights less than about 1000 but greater than about 100.

13. The method of claim 11 wherein the prepolymer activator component is made with polyoxypropylene diols and triols such that at least 20 percent of the starting polyols have hydroxyl equivalent weights less than about 1000, but greater than about 50.

14. The method of claim 11 wherein the polyoxyalkylene polyol comprises a diol, a triol or higher functionality polyol.

15. The method of claim 11 wherein the polyoxyalkylene polyol is at least one of polyether polyols, polyester polyols, or combinations thereof.

16. The method of claim 11 wherein the polyoxyalkylene polyol is at least one of polypropylene glycols, polyethylene glycols, polytetramethylene glycols, polycaprolactone diols, polycaprolactone triols, or combinations thereof.

17. The method of claim 11 wherein the polyisocyanate comprises at least one of methylene diphenyl diisocyanates, toluene diisocyanates, polymeric methylene diphenyl diisocyanate, p-phenyl diisocyanate, naphthalene diisocyanate, hexamethylene diisocyanates, hexamethylene diisocyanate trimers, dicyclohexylmethane diisocyanates, isophorone diisocyanates, cyclohexane diisocyanate, tetramethylxylylene diisocyanate, or mixtures thereof.

18. The method of claim 11 wherein the ratio of polyisocyanate equivalents to polyol equivalents is about 1.1:1 to about 5:1.

19. The method of claim 11 wherein the polyurethane sealant additionally comprises at least one of thixotropic agents, fillers, plasticizers, antioxidants, UV stabilizers, fungicides, mildewcides, biocides, fire retardants, coloring agents, surface additives, adhesion promoters, rheology modifiers, catalysts, defoaming agents, solvents, drying agents, or mixtures thereof.

20. The method of claim 11 wherein the polyoxyalkylene polyols of the reaction product has a molecular weight in the range of about 500 to about 4500.
